(19) United States
(12) Patent Application Publication
(10) Pub. No.: US 2024/0113652 A1
(43) Pub. Date: Apr. 4, 2024

(54) TORQUE TUBE WITH PENTAGONAL CROSS-SECTION AND SOLAR STRUCTURE

(71) Applicant: ARCTECH SOLAR HOLDING CO., LTD., Kunshan (CN)

(72) Inventors: Ying YANG, Kunshan (CN); Jingqiang CHEN, Kunshan (CN); Yupei XIE, Kunshan (CN)

(73) Assignee: ARCTECH SOLAR HOLDING CO., LTD., Kunshan (CN)

(21) Appl. No.: 18/268,606

(22) PCT Filed: Jul. 2, 2021
(86) PCT No.: PCT/CN2021/104133

§ 371 Date: Jun. 21, 2023

(30) Foreign Application Priority Data
Apr. 28, 2021 (CN) 202120896203.9

(51) Int. Cl. H02S 20/30; F24S 30/425

(52) U.S. Cl. CPC H02S 20/30; F24S 30/425; F24S 2030/15

(57) ABSTRACT

A torque tube with a pentagonal cross-section includes a tube body and a cavity disposed in the tube body. The cross-section of the tube body of the length direction is a convex pentagon including a first side, a second side, a third side, a fourth side, and a fifth side that are connected end to end in a circumferential direction to form a closed structure. The tube body is a symmetrical structure with a perpendicular bisector of the third side as an axis, such that the second side is symmetrical with the fourth side, the first side is symmetrical with the fifth side, and the second side and the fourth side are vertically connected to the third side. A solar structure is further provided. The special pentagonal structure of the torque tube provides an additional cross-section for selection while ensuring strength and flexural performance and saving on material costs.

### CROSS REFERENCE TO THE RELATED APPLICATIONS

This application is the national phase entry of International Application No. PCT/CN2021/104133, filed on Jul. 2, 2021, which is based upon and claims priority to Chinese Patent Application No. 202120896203.9, filed on Apr. 28, 2021, the entire contents of which are incorporated herein by reference.

### TECHNICAL FIELD

The application relates to the technical field of solar structure, and more particularly to a torque tube with a pentagonal cross-section and a solar structure.

### BACKGROUND

In the prior art, photovoltaic power generation has become a trend and is widely used in various places. Photovoltaic power generation is a technology that directly converts solar energy into electrical energy based on the principle of the photovoltaic effect. Whether used independently or combined with the grid, a photovoltaic power generation system mainly includes a solar module, a controller, and an inverter. To keep the high-power generation efficiency of the solar module, a solar structure is developed. The solar module is installed on the main beam which drives the solar module to rotate as to track the movement of the sun.

The main beam is generally a torque tube. At present, the torque tubes in the market are mostly D-shaped tubes, round tubes, square tubes, and the like. However, for the solar structure, material cost, strength, and flexural performance are long-term topics and directions for improvement. On this basis, to further reduce the material cost and increase the flexural performance of components, it is necessary to design a torque tube with a new cross-section to provide more cross-sections for selection while ensuring the strength, flexural performance, and material cost.

### SUMMARY

To resolve the above technical problems, the application provides a torque tube with a pentagonal cross-section and a solar structure, such that a cross-section of the torque tube is a special pentagonal structure, which resolves the problem of a single cross-section of a profile used as the main beam of the solar tracking support currently used in the market and provides more cross-sections for selection while ensuring strength and flexural performance and reducing material cost.

The application adopts the following technical solutions:

A torque tube with a pentagonal cross-section used as a rotating main beam includes a tube body and a cavity disposed in the tube body.

The cross-section of the tube body of the length direction is a convex pentagon including a first side, a second side, a third side, a fourth side, and a fifth side that are connected end to end in a circumferential direction to form a closed structure.

The tube body is a symmetrical structure with a perpendicular bisector of the third side as an axis. The second side is symmetrical with the fourth side, the first side is symmetrical with the fifth side, and the second side and the fourth side are vertically connected to the third side.

In this technical solution, the third side of the torque tube is used as a mounting-specific reference plane to position a solar module when mounting the solar module, which helps mounting personnel to mount a plurality of solar modules on the same plane. The second side and the fourth side are perpendicular to the third side, the second side and the fourth side are symmetrical along the perpendicular bisector of the third side, and the first side and the fifth side are symmetrical along the perpendicular bisector of the third side. In other words, the torque tube is a symmetrical structure along the perpendicular bisector of the third side. The cross-section of the torque tube having the above pentagonal structure resolves the problem of a single cross-section of a profile used as the main shaft of the tracking support currently used in the market and provides more cross-sections for selection while ensuring strength and flexural performance and saving on material costs.

Further, preferably, an interior angle formed by the first and second sides is between 110° and 120°.

Further, preferably, the second side, the third side, and the fourth side are equal in length.

Further, preferably, a first junction between the endpoints of the first side and the second side, a second junction between the endpoints of the second side and the third side, a third junction between the endpoints of the third side and the fourth side, a fourth junction between the endpoints of the fourth side and the fifth side, and a fifth junction between the endpoints of the fifth side and the first side are all round-fillet.

The radius of the round fillet between the second side and the third side is equal to that of the round fillet between the third side and the fourth side.

Additionally, the radius of the round fillet between the first side and the second side is equal to that of the round fillet between the fourth side and the fifth side and equal to that of the round fillet between the fifth side and the first side.

In this technical solution, all corners of the torque tube are rounded, such that the tube body can transfer force to an arc wall during torsion, which effectively transfers torque, optimize the internal stress of the torque tube, and enhance fastness. A transition section formed by the round fillet can reduce the internal stress of the tube body at a junction and increase structural stability. With a central symmetrical structure, the torque tube is easy to process, structurally stable, and beautiful.

Further, preferably, the radius of the round fillet between the second side and the third side is greater than that of the round fillet between the first side and the second side.

Further, preferably, the torque tube has a pentagonal cross-section at any position extending along the length direction of the tube body.

Further, preferably, any position extending along the length direction of the tube body has the same pentagonal cross-section, and each side of the pentagonal cross-section has the same thickness.

Another technical solution provided by the application is as follows:

A solar structure includes:
a plurality of pillars disposed at intervals along a straight line, where a top of each of the pillars is provided with a bearing module;
the above-mentioned torque tube with a pentagonal cross-section, where the torque tube is rotatably and sequentially disposed on the top of the plurality of pillars through the bearing modules; and
a plurality of solar modules, where the solar modules are sequentially disposed along an axial direction of the torque tube and capable of rotating together with the torque tube.

Further, preferably, the third side of the torque tube faces the solar module, and the solar module is mounted on the third side by purlins.

Further, preferably, the bearing module includes:
a mounting stand, where a plurality of bolts penetrate through the mounting stand and are fixedly connected to the pillar;
a bearing seat disposed on the mounting stand, where the bearing seat is provided with a bearing hole; and
a bearing, where the bearing is provided with a mounting hole, and the torque tube is fitted in the mounting hole.

Compared with the prior art, the torque tube with a pentagonal cross-section and the solar structure in the application have the following beneficial effects:

In the application, the third side of the torque tube is used as a mounting-specific reference plane to position the solar module when mounting the solar module, which helps mounting personnel to mount the solar modules on the same plane. The second side and the fourth side are symmetrical along the perpendicular bisector of the third side, and the first side and the fifth side are symmetrical along the perpendicular bisector of the third side. In other words, the torque tube is a symmetrical structure along the perpendicular bisector of the third side. Experimental data shows that the pentagonal cross-section of the torque tube resolves the problem of a single cross-section of a profile used as the main shaft of the tracking support currently used in the market and provides an additional cross-section for selection while ensuring strength and flexural performance and saving on material costs.

### BRIEF DESCRIPTION OF THE DRAWINGS

Preferred implementations will be described below in a clear and easy-to-understand manner in conjunction with the drawings to further illustrate the above-mentioned characteristics, technical features, advantages, and implementation methods.

FIG. 1 is a schematic structural diagram of a torque tube according to an embodiment of the application;

FIG. 2 is a schematic cross-sectional view of a torque tube according to an embodiment of the application;

FIG. 3 is a schematic structural diagram of a solar structure according to another embodiment of the application;

FIG. 4 is a schematic diagram of a local structure of a solar structure according to another embodiment of the application; and

FIG. 5 is a schematic diagram of a local structure of a solar structure from another angle of view according to another embodiment of the application.

### DESCRIPTION OF REFERENCE NUMERALS

1: torque tube; 11: tube body; 12: cavity; 111: first side; 112: second side; 113: third side; 114: fourth side; 115: fifth side; 2: pillar; 3: bearing module; 31: mounting stand; 32: bearing seat; 33: bearing; 331: upper bearing; 332: lower bearing; 333: limit groove; 334: first mounting slot; 335: second mounting slot; and 4: solar module.

### DETAILED DESCRIPTION OF THE EMBODIMENTS

In the following description, specific details, such as a specific system structure and a technology are provided for description instead of limitation, to thoroughly understand embodiments of the application. However, those skilled in the art should understand that the application may also be implemented in other embodiments without these specific details. In other cases, detailed descriptions of a well-known system, apparatus, circuit, and method are omitted to avoid unnecessary details interfering with the description of the application.

It should be understood that when used in this specification and the appended claims, the terms “comprise” and “include” indicate the presence of described features, integers, steps, operations, elements, and/or components but do not exclude the presence or addition of one or more of other features, integers, steps, operations, elements, components, and/or sets thereof.

To keep the drawings concise, only components related to the application are schematically illustrated in each drawing, which does not represent its actual structure as a product. In addition, to make the drawings simple and easy to understand, in some drawings, only one of the components having the same structure or function is schematically shown or marked. In this specification, “one” not only means “only this one” but also means “more than one”.

It should also be further understood that the term “and/or” used in this specification of the application and the appended claims refers to one or any or all possible combinations of a plurality of associated items that are listed and includes these combinations.

In the embodiments shown in the drawings, indications of directions (such as upper, lower, left, right, front, and rear), which are relative but not absolute, are used for explaining structures and movements of various components of the application. Such descriptions are appropriate when the components are located at positions shown in the drawings. If the descriptions of the positions of the components change, the indications of the directions change accordingly.

In addition, in the description of the application, the terms, such as “first” and “second,” are used only for distinguishing the description and cannot be understood to indicate or imply relative importance.

To explain the technical solutions in the embodiments of the application or in the prior art more clearly, the specific implementations of the application will be described below with reference to the drawings. Apparently, the drawings in the following description show merely some embodiments of the application, and other drawings and other implementations may be derived from these drawings by a person of ordinary skill in the art without creative efforts.

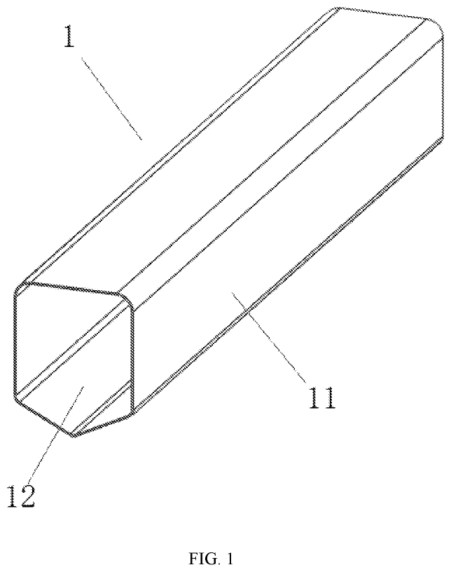

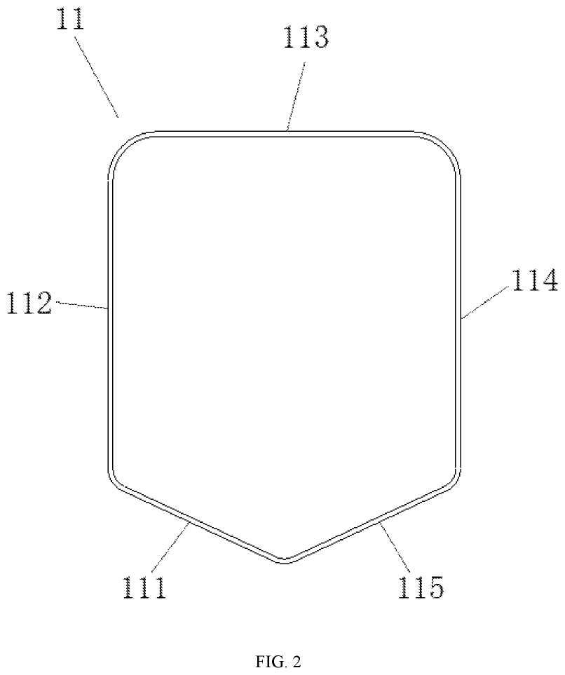

As a specific embodiment, as shown in FIG. 1 and FIG. 2, an embodiment provides a torque tube 1 with a pentagonal cross-section. The torque tube 1 is used as a rotating main beam, and includes a tube body 11 and a cavity 12 disposed in the tube body 11. A cross-section of the tube body 11 taken along the length direction is a convex pentagon including a first side 111, a second side 112, a third side 113, a fourth side 114, and a fifth side 115 that are connected end to end in a circumferential direction to form a closed structure. The tube body 11 is a symmetrical structure with a perpendicular bisector of the third side 113 as an axis, where the second side 112 is symmetrical with the fourth side 114, the first side 111 is symmetrical with the fifth side 115, and the second side 112 and the fourth side 114 are vertically connected to the third side 113.

Further, the interior angle formed by the first side 111 and the second side 112 is between 110° and 120°, such as 112°, 115°, 118°, or the like. The second side 112, the third side 113, and the fourth side 114 are equal in length. The first side 111 and the fifth side 115 are equal in length, and their lengths are determined by the size of the interior angle formed by the first side 111 and the second side 112. For example, if the interior angle formed by the first side 111 and the second side 112 is 120°, the lengths of the second side 112, the third side 113, and the fourth side 114 are each 160 mm long. In this case, the lengths of the first side 111 and the fifth side 115 are each 100 mm.

In this embodiment, the third side 113 of the torque tube 1 is used as a mounting-specific reference plane to position a solar module when mounting the solar module, which helps mounting personnel to mount a plurality of solar modules on the same plane. The second side 112 and the fourth side 114 are symmetrical along a perpendicular bisector of the third side 113, and the first side 111 and the fifth side 115 are symmetrical along the perpendicular bisector of the third side 113. In other words, the torque tube 1 is a symmetrical structure along the perpendicular bisector of the third side 113. The cross-section of the torque tube 1 with the above pentagonal structure resolves the problem of a single cross-section of a profile used as the main shaft of the tracking support currently used in the market and provides an additional cross-section for selection while ensuring strength and flexural performance and reducing material cost.

In another embodiment, as shown in FIG. 1 and FIG. 2, based on the above embodiment, the first side 111 and the second side 112, the second side 112 and the third side 113, the third side 113 and the fourth side 114, the fourth side 114 and the fifth side 115, and the fifth side 115 and the first side 111 are all rounded. All corners of the torque tube 1 are rounded, such that the tube body 11 can transfer force to an arc wall during torsion, which effectively transfers a torque, optimizes the internal stress of the torque tube 1, and enhances fastness. The transition section formed by a fillet can reduce the internal stress of the tube body 11 at a junction and increase structural stability.

Preferably, the radius of the round fillet between the second side 112 and the third side 113 is equal to that of the round fillet between the third side 113 and the fourth side 114. Additionally, the radius of the round fillet between the first side 111 and the second side 112 is equal to that of the round fillet between the fourth side 114 and the fifth side 115 and to that of a fillet between the fifth side 115 and the first side 111. With a central symmetrical structure, the torque tube 1 is easy to process and structurally stable. The torque tube 1 has no outer edge, which makes it convenient to mount a pivotal bearing on the pillar.

Further, the radius of the round fillet between the second side 112 and the third side 113 is twice that of the round fillet between the first side 111 and the second side 112. For example, the radius of the round fillet between the second side 112 and the third side 113 is equal to the radius of the round fillet between the third side 113 and the fourth side 114, and their radiuses are 20 mm. In another example, the radius of the round fillet between the first side 111 and the second side 112 is equal to the radius of the round fillet between the fourth side 114 and the fifth side 115 and the radius of the round fillet between the fifth side 115 and the first side 111, and their radiuses are 10 mm.

In another embodiment, as shown in FIG. 1 and FIG. 2, based on the above embodiment, any position extending along the length direction of the tube body 11 has the same pentagonal cross-section, and each side of the pentagonal cross-section has the same thickness. The thickness of each side of the pentagonal cross-section is 1.5 mm to 2.5 mm and is preferably 2 mm. The torque tube 1 may be made of galvanized steel alloys, carbon steel, composite fiber, or plastic.

Further, the torque tube 1 with a pentagonal cross-section includes a welding seam extending along an outer surface parallel to the length direction of the tube body 11. The torque tube 1 can be obtained through welding after integral bending for four or five times. Alternatively, the tube body is integrally formed by using a cold roll forming process. The torque tube 1 integrally formed by using the cold roll forming process can be easily mounted, conserve material use, and enhance strength, thereby improving the strength of the torque tube 1, reducing mounting fees, and meeting the personalized needs of users.

Taking a D-shaped tube as a reference below, tests are conducted to compare a square tube and the torque tube with a pentagonal cross-section in the above embodiment. The outer diameter of the D-shaped tube is 133 mm, and the thickness of the D-shaped tube is 3 mm. The side length of the square tube is 140 mm, the four sides are each 2.3 mm long, and the radiuses of the four fillets are each 30 mm. The five sides of the torque tube with a pentagonal cross-section are 80 mm, 145 mm, 145 mm, 145 mm, and 80 mm long, respectively. The five sides of torque tube 1 are all 2 mm thick. The radius of the round fillet between the second side 112 and the third side 113 is equal to the radius of the round fillet between the third side 113 and the fourth side 114, and their radiuses are each 20 mm. The radius of the round fillet between the first side 111 and the second side 112 is equal to the radius of the round fillet between the fourth side 114 and the fifth side 115 and to the radius of the round fillet between the fifth side 115 and the first side 111, and their radiuses are each 10 mm. Test data obtained is as follows:

| | Wall | | | | Torsional | |
|---|---|---|---|---|---|---|
| | thickness | Material | Bended | Bended | bearing | Torsional |
| Type | (mm) | cost | by 0° | by 60° | capacity | rigidity |
| D-shaped tube | 3 | 1.00 | 1.00 | 1.00 | 1.00 | 1.00 |
| Square tube | 2.3 | 96% | 135% | 123% | 112% | 130% |
| Torque tube with a | 2 | 94% | 194% | 151% | 121% | 155% |
| pentagonal | | | | | | |
| cross-section | | | | | | |

It can be seen from the above table that if the material cost of the D-shaped tube is a, the material cost of the square tube is 0.96a, and the material cost of the torque tube with a pentagonal cross-section is 0.94a. When the other performance is not lowered, the torque tube with a pentagonal cross-section has a lower material cost than the D-shaped tube and the square tube. Therefore, the cost input of the torque tube with a pentagonal cross-section is reduced.

If the force required to bend the D-shaped tube by 0° (when bending just occurs) is b, the force required to bend the square tube by 0° is 1.35b, and the force required to bend the torque tube with a pentagonal cross-section by 0° is 1.94b. Therefore, without increasing the cost input, the force required to bend the torque tube with a pentagonal cross-section by 0° is significantly greater than the force required to bend the D-shaped tube by 0° and the force required to bend the square tube by 0°, which indicates that the torque tube with a pentagonal cross-section has better flexural performance than the D-shaped tube and the square tube.

If the force required to bend the D-shaped tube by 60° is c, the force required to bend the square tube by 60° is 1.23c, and the force required to bend the torque tube with a pentagonal cross-section by 60° is 1.51c. Therefore, without increasing the cost input, the force required to bend the torque tube with a pentagonal cross-section by 60° is significantly greater than the force required to bend the D-shaped tube by 60° and the force required to bend the square tube by 60°, which indicates that the torque tube with a pentagonal cross-section has better flexural performance than the D-shaped tube and the square tube.

If the force required to bend the torsional bearing of the D-shaped tube is d, the force required to bend the torsional bearing of the square tube is 1.12d, and the force required to bend the torsional bearing of the torque tube with a pentagonal cross-section is 1.21d. Therefore, without increasing the cost input, the force required to bend the torsional bearing of the D-shaped tube is significantly greater than the force required to bend the torsional bearing of the square tube and the force required to bend the torsional bearing of the torque tube with a pentagonal cross-section, which indicates that the torque tube with a pentagonal cross-section has a higher torsional bearing capacity than the D-shaped tube and the square tube.

If the force required to torsionally deform the D-shaped tube is e, the force required to torsionally deform the square tube is 1.30e, and the force required to torsionally deform the torque tube with a pentagonal cross-section is 1.55e. Therefore, without increasing the cost input, the force required to torsionally deform the torque tube with a pentagonal cross-section is significantly greater than the force required to torsionally deform the D-shaped tube and the force required to torsionally deform the square tube, which indicates that the torque tube with a pentagonal cross-section has higher torsional rigidity than the D-shaped tube and the square tube.

Compared with the D-shaped tube and the square tube, the torque tube with a pentagonal cross-section has better flexural performance, higher torsional rigidity, and higher torsional bearing capacity. Therefore, fewer materials are required to perform the same task in the torque tube with a pentagonal cross-section. Compared with the D-shaped tube and the square tube, the torque tube with a pentagonal cross-section increases flexural performance and reduces the material and overall cost. In addition, the torque tube with a pentagonal cross-section has a novel cross-sectional structure and is convenient for large-scale production modeling. The torque tube with a pentagonal cross-section is connected to the main shaft reducer of the same specification, which saves materials, reduces the material cost, and achieves a simple structure and beautiful appearance.

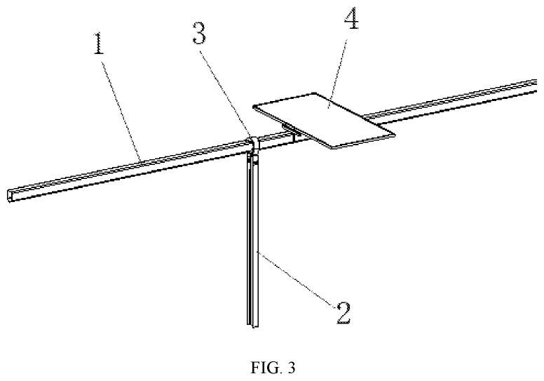

In another embodiment, as shown in FIG. 3 to FIG. 5, based on the above embodiment, an embodiment provides a solar structure, including a torque tube 1, a plurality of pillars 2 disposed side by side at intervals, and a plurality of solar modules 4. The torque tube 1 includes a tube body 11 and a cavity 12 disposed in the tube body 11. Any position extending along a length direction of the tube body 11 has a pentagonal cross-section. The pentagonal cross-section is a convex pentagon including a first side 111, a second side 112, a third side 113, a fourth side 114, and a fifth side 115 that are sequentially connected. The third side 113 is configured to mount the solar module, the second side 112 and the fourth side 114 are perpendicular to the third side 113, and an interior angle formed by the first side 111 and the second side 112 is equal to that formed by the fourth side 114 and the fifth side 115. The top of each of the pillars 2 is provided with a bearing module 3. The torque tube 1 is adaptively connected to the bearing module 3, such that the torque tube 1 can rotate on the pillar 2. The solar modules 4 are sequentially disposed along an axial direction of the torque tube 1 and can rotate together with the torque tube 1.

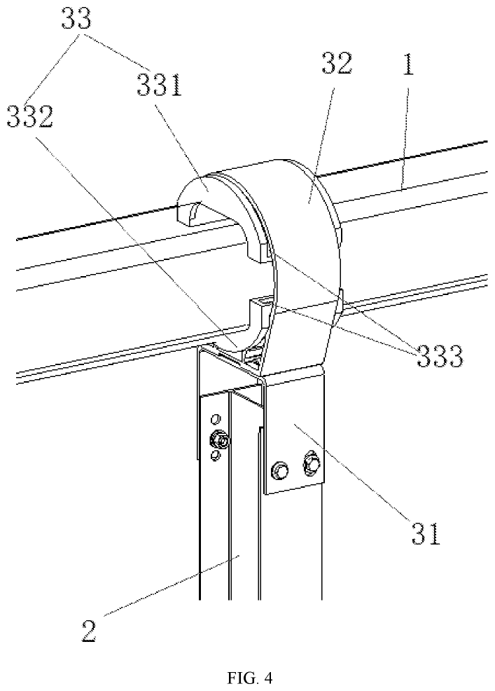

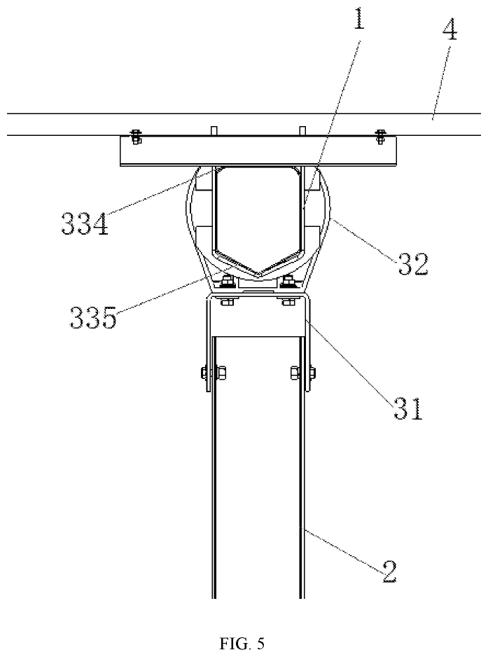

Specifically, as shown in FIG. 4 and FIG. 5, the bearing module 3 includes a mounting stand 31, a bearing seat 32, and a bearing 33. The mounting stand 31 is of a U-shaped structure, and the top end of the pillar 2 is inserted into a notch of the U-shaped structure and fixed by using a bolt. The bearing seat 32 is fixed on the mounting stand 31 by using a bolt. The bearing seat 32 is of a ring structure and has a bearing hole inside. The bearing 33 is of a separated structure, and includes an upper bearing 331 and a lower bearing 332. Outer circumferential surfaces of the upper bearing 331 and the lower bearing 332 each are provided with an axial limit groove 333. A lower end of the upper bearing 331 is provided with a first mounting slot 334, and an upper end of the lower bearing 332 is provided with a second mounting slot 335. The first mounting slot 334 and the second mounting slot 335 together form a mounting hole. The torque tube 1 is fitted in the mounting hole, such that an upper portion of the second side 112, the third side 113, and an upper portion of the fourth side 114 are fitted with an inner sidewall of the first mounting slot 334, and a lower portion of the second side 112, the first side 111, the fifth side 115, and a lower portion of the fourth side 114 are fitted to an inner sidewall of the second mounting slot 335.

In this embodiment, the bearing 33 is of the separated structure, such that the bearing seat 32 does not need to be separated. During mounting, it is only necessary to put the upper bearing 331 and the lower bearing 332 into the bearing seat 32, clamp an upper end of the bearing seat 32 in the limit groove 333 of the upper bearing 331, clamp a lower end of the bearing seat 32 in the limit groove 333 of the lower bearing 332, and then make the torque tube 1 penetrate through the mounting hole to mount the torque tube 1. This simplifies operation steps and improves mounting efficiency.

It is worth noting that in this embodiment, the bearing 33 may alternatively be of an integral structure. For example, the bearing 33 may be rotatably mounted in a bearing hole, the bearing 33 has a first connecting end and a second connecting end, and the bearing 33 also has a mounting hole for mounting the torque tube 1. A first stopper is connected to the first connecting end of the bearing 22, a second stopper is connected to the second connecting end of the bearing 33, and the first stopper and the second stopper are respectively located on both sides of the bearing seat 32 to limit relative positions of the bearing 33 and the bearing seat 32, so as to mount the bearing 33 and the bearing seat 32.0f course, another mounting method or structure may alternatively be used, and any mounting method or structure that can realize a rotatable connection between the torque tube 1 and the pillar 2 falls within the protection scope of the application.

In the above embodiments, the description of each of the embodiments has a focus, and portions not described or recorded in detail in one embodiment may refer to related description in other embodiments.

It should be noted that the above embodiments can be freely combined as required. The above descriptions are merely preferred implementations of the application. It should be noted that a person of ordinary skill in the art may further make several improvements and modifications without departing from the principle of the application, but such improvements and modifications should be deemed as falling within the protection scope of the application.

What is claimed is:

1. A torque tube with a pentagonal cross-section, used as a rotating main beam, comprising a tube body and a cavity disposed in the tube body, wherein
a cross-section of the tube body in a length direction is a convex pentagon comprising a first side, a second side, a third side, a fourth side, and a fifth side, wherein the first side, the second side, the third side, the fourth side, and the fifth side are connected end to end in a circumferential direction to form a closed structure;
the tube body is a symmetrical structure with a perpendicular bisector of the third side as an axis, the second side is symmetrical with the fourth side, the first side is symmetrical with the fifth side, and the second side and the fourth side are vertically connected to the third side.

2. The torque tube with the pentagonal cross-section according to claim 1, wherein
an interior angle formed by the first side and the second side is between 110° and 120°.

3. The torque tube with the pentagonal cross-section according to claim 2, wherein
the second side, the third side, and the fourth side are equal in length.

4. The torque tube with the pentagonal cross-section according to claim 1, wherein
a first junction between endpoints of the first side and the second side forms a first round fillet, a second junction between endpoints of the second side and the third side forms a second round fillet, a third junction between endpoints of the third side and the fourth side forms a third round fillet, a fourth junction between endpoints of the fourth side and the fifth side forms a fourth round fillet, and a fifth junction between endpoints of the fifth side and the first side forms a fifth round fillet;
a radius of the second round fillet between the second side and the third side is equal to a radius of the third round fillet between the third side and the fourth side; and/or
a radius of the first round fillet between the first side and the second side is equal to a radius of the fourth round fillet between the fourth side and the fifth side and equal to a radius of the fifth round fillet between the fifth side and the first side.

5. The torque tube with the pentagonal cross-section according to claim 4, wherein
the radius of the second round fillet between the second side and the third side is greater than the radius of the first round fillet between the first side and the second side.

6. The torque tube with the pentagonal cross-section according to claim 1, wherein
the torque tube has a pentagonal cross-section at any position extending along the length direction of the tube body.

7. The torque tube with the pentagonal cross-section according to claim 6, wherein
any position extending along the length direction of the tube body has the same pentagonal cross-section, and each side of the pentagonal cross-section has a same thickness.

8. A solar structure, comprising:
a plurality of pillars disposed at intervals along a straight line, wherein a top of each of the plurality of pillars is provided with a bearing module;
the torque tube with the pentagonal cross-section according to claim 1, wherein the torque tube is rotatably and sequentially disposed on the top of each of the plurality of pillars through the bearing module;
a plurality of solar modules, wherein the plurality of solar modules are sequentially disposed along an axial direction of the torque tube and configured to rotate together with the torque tube.

9. The solar structure according to claim 8, wherein
the third side of the torque tube faces toward the plurality of solar modules, and the plurality of solar modules are mounted on the third side by purlins.

10. The solar structure according to claim 9, wherein the bearing module comprises:
a mounting stand, wherein a plurality of bolts penetrate through the mounting stand and are fixedly connected to each of the plurality of pillars;
a bearing seat disposed on the mounting stand, wherein the bearing seat is provided with a bearing hole;
a bearing, wherein the bearing is provided with a mounting hole, and the torque tube is fitted in the mounting hole.

11. The solar structure according to claim 8, wherein in the torque tube,
an interior angle formed by the first side and the second side is between 110° and 120°.

12. The solar structure according to claim 11, wherein in the torque tube,
the second side, the third side, and the fourth side are equal in length.

13. The solar structure according to claim 8, wherein in the torque tube,
a first junction between endpoints of the first side and the second side forms a first round fillet, a second junction between endpoints of the second side and the third side forms a second round fillet, a third junction between endpoints of the third side and the fourth side forms a third round fillet, a fourth junction between endpoints of the fourth side and the fifth side forms a fourth round fillet, and a fifth junction between endpoints of the fifth side and the first side forms a fifth round fillet;
a radius of the second round fillet between the second side and the third side is equal to a radius of the third round fillet between the third side and the fourth side; and/or
a radius of the first round fillet between the first side and the second side is equal to a radius of the fourth round fillet between the fourth side and the fifth side and equal to a radius of the fifth round fillet between the fifth side and the first side.

14. The solar structure according to claim 13, wherein in the torque tube,
the radius of the second round fillet between the second side and the third side is greater than the radius of the first round fillet between the first side and the second side.

15. The solar structure according to claim 8, wherein in the torque tube,
the torque tube has a pentagonal cross-section at any position extending along the length direction of the tube body.

16. The solar structure according to claim 15, wherein in the torque tube,
any position extending along the length direction of the tube body has the same pentagonal cross-section, and each side of the pentagonal cross-section has a same thickness.
